(19) United States
(12) Patent Application Publication
(10) Pub. No.: US 2020/0213647 A1
(43) Pub. Date: Jul. 2, 2020

(54) METHOD AND SYSTEM FOR PROVIDING AN ELECTRONIC VIDEO CAMERA GENERATED LIVE VIEW OR VIEWS TO A USER'S SCREEN

(71) Applicants: David G. PERRYMAN, Decatur, GA (US); Kevin RYTER, Decatur, GA (US)

(72) Inventors: David G. PERRYMAN, Decatur, GA (US); Kevin RYTER, Decatur, GA (US)

(21) Appl. No.: 16/633,732

(22) PCT Filed: Aug. 3, 2018
(86) PCT No.: PCT/US2018/045119

§ 371 Date: Jan. 24, 2020

Related U.S. Application Data
(60) Provisional application No. 62/540,690, filed on Aug. 3, 2017.

(51) Int. Cl. H04N 21/25; H04N 21/2187; H04N 21/482

(52) U.S. Cl. CPC H04N 21/251; H04N 21/4826; H04N 21/2187

(57) ABSTRACT

A system and method of providing an electronic video camera generated live view or views to a user's screen comprising providing live views to the viewer that are curated to display a selected view or views. Also provided is a method of providing electronic camera generated view or views to a user's screen comprising providing a curated view or platform of views to the viewer wherein an electronic means of calculating views is utilized to display the current most active view or views. Such views can be provided in categories of interest to the viewer. This invention provides a means whereby the world's best live views can be provided to the individual viewer in an efficient, interesting, and entertaining manner.

### CROSS-REFERENCE TO RELATED APPLICATION

This application claims priority to and benefit of U.S. provisional patent application Ser. No. 62/540,690 filed Aug. 3, 2017, which is fully incorporated by reference and made a part hereof.

### BACKGROUND

Unedited video content, such as live webcams or live broadcasts on the web, while highly interesting and important, suffer from long periods of inactive, repetitive activity, and lack efficient prioritization. The viewer is left to scroll for something interesting that is live in an inefficient, frustrating and often boring process.

People also seek views from wherever they are situated or domiciled. Live views, such as scenic mountains or cities, can be extremely expensive and thus the world's best views are simply unobtainable to the masses.

Therefore, solutions are desired to overcome these and other challenges in the art.

### SUMMARY

Described herein are embodiments of a system and a method of providing an electronic video camera generated live view or views to a user's screen comprising providing live views to the viewer that are curated to display a selected view or views. Also provided is a method of providing electronic camera generated view or views to a user's screen comprising providing a curated view or platform of views to the viewer wherein an electronic means of calculating views is utilized to display the current most active view or views. Such views can be provided in categories of interest to the viewer. This invention provides a means whereby the world's best live views can be provided to the individual viewer in an efficient, interesting, and entertaining manner.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary overview diagram of a system for providing an electronic video camera generated view or views to a user's screen comprising providing views to the viewer that are curated to display a selected view or views; and

FIG. 2 is a block diagram illustrating an exemplary operating environment for performing the disclosed methods.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks. CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Disclosed and described herein are embodiments of a system, method and computer program product of an electronic video camera generated live view or views to a user's screen.

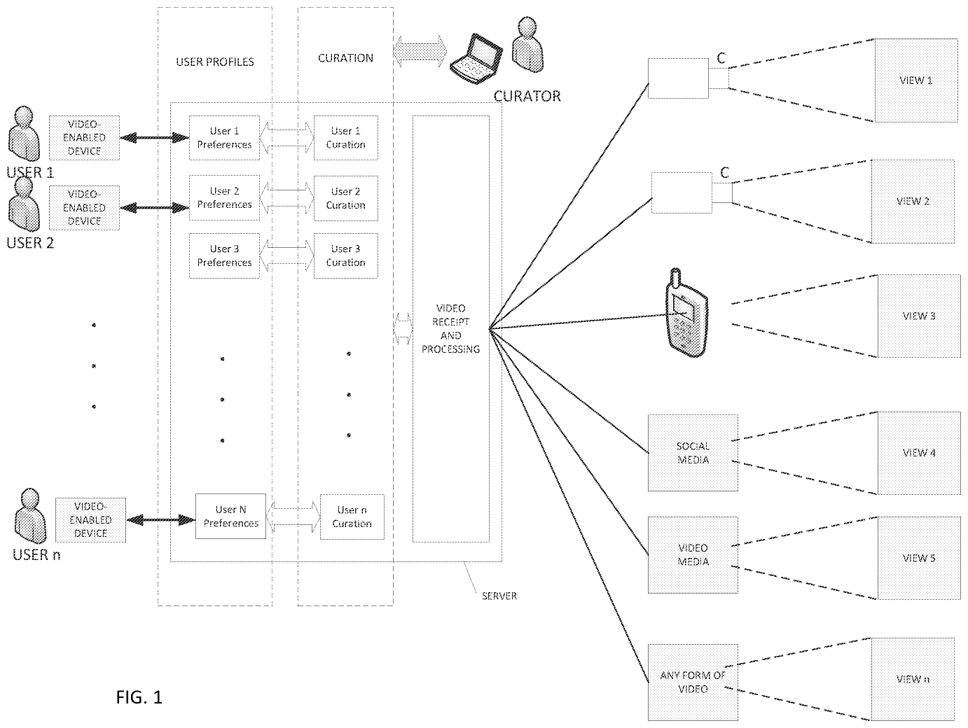

FIG. 1 is an exemplary overview diagram of a system for providing an electronic video camera generated view or views to a user's screen comprising providing views to the viewer that are curated to display a selected view or views. The viewer can also be referred to as the “user” herein. By “curated” it is meant that the view or views on the viewer's screen is selected from many available input views and the view or views of most potential interest to the viewer are displayed on the viewer's screen. The curation can either be by human or electronic means. In the case of curation by human means, one or more humans are viewing a multitude of live video inputs and the human, at least in part, directs the display of the view or views to the viewer's screen that are believed to provide the most interest to the viewer. In the case of electronic means of curation, the number of viewers and/or the length of views of a multiple of live video inputs are measured and the viewer's screen displays those video inputs that have the most live viewers and/or longest active viewing.

In one embodiment, the view provided to a user's video-enabled device is within a category of interest selected by the user and/or selected electronically based on a user profile. A user can have one or more categories of interest, which comprise a user's preferences. The user profile can, for example, be generated by the user, or be generated based on the user's web searching habits.

One example of video inputs is live webcams. Most often the webcams are fixed but could also be mounted to a moving object such as a vehicle or an animal. A second example of live video inputs can come from individuals or groups of individual's cameras, from for example smart phones that are linked into the source of available live video inputs. In one embodiment, all smartphones become part of a network of inputs that are curated within selected categories to produce the most relevant inputs in that category on the viewer's screen. Categories can include for example, news, sporting events and scenic views. Specifically, scenic views, for example live video input from a webcam on a high-rise building, city scape or from a mountain, can be viewed and can be curated to the viewer's interest. Such a scenic view can be maintained on the user's screen, for example, to provide an electronic equivalent of a great view from a standard window. In this example, the screen displaying the scenic view could be mounted much like a window on a wall to further enhance the perception of a scenic view. In another example, video media such as live news can be viewed for whatever is currently occurring live at the time, for example a crime being committed. As another example, social media can provide video inputs. For example, Facebook Liver™ and Instagram™ live input, or Twitter™ linked live broadcasts are curated in a category of interest so that the most viewed in a category of the viewer's interest is displayed to the user's screen.

Further comprising the system of FIG. 1 is a server. As used herein, ‘server’ can mean one server or a plurality of servers. If a plurality of servers, they may be located together or in various locations and connected by a network. The server not only receives and processes video inputs, but also curates the view inputs based on user preferences define in user profiles. Additionally, the server may allow a human curator to view video inputs and suggest them to users based on the user's profile and/or viewing interests and habits.

The server executes several algorithms embodied as computer-executable instructions. Such algorithm may include determining the most and/or longest viewed live video input (i.e. to determine what is most viewed or trending). Users may indicate an interest in trending views, in such case trending views can be presented to those users. Optionally or alternatively, image scanning algorithms can identify the content of live video streams and provide or suggest such live video streams to users based on the users' profiles. Also alternatively or optionally, human curators can watch live video streams of trending views and route them to users based on users' profiles and/or the amount of time or frequency that a user spends viewing similar views.

As noted herein, views can be selected for a user using electronic, automated selection (based on user criteria such as the user's profile, viewing time of specific topics, viewing frequency of specific topics, etc.), or based on human curated desired panoramic views. These views can be further selected by the viewer. For example, a user may be presented with several views based on the user's profile, viewing habits, etc., and the viewer can select from the available list of views. Alternatively, the viewer may enter a “browse” mode where the viewer can browse through categories of live views and select those that the viewer may be interested in viewing.

In one of the embodiments, the server is able to identify only those video inputs or cameras that are functional and thus are displayed. This, for example, avoids the common problem with webcam viewing that links to cameras which are dead or non-functional and the viewer's time is wasted trying to connect or view the camera that is failing to provide the video input. Video inputs or cameras have continued to improve in quality and provide the ability to view recently recorded events on that camera. One example of a camera that can be used in embodiments described herein is a Nestcam™. Also provided by the server is the storage, archiving and retrieval of past views. For example, past views that have been recorded that are related to the interest of the viewer may be suggested and/or provided to a user by the server.

The video-enabled device used by the viewer can be any electronic screen used in the art, for example, the screen can include computers, TVs, handheld smart devices, display panels, and the like.

As noted herein, the views can be catalogued and curated either by the server and/or by a human curator by a broader defined category. e.g. Paris, Yellowstone National Park, Hollywood, a building location, a state, or a city. Likewise, the view can be catalogued and curated by a non-border defined category, e.g. outdoors, wilderness, people, animals, shopping, sunsets, sunrises, moonrises, eclipses, northern lights, comets, shooting stars, camp sites, undersea, and the like. In one exemplary embodiment, a user can select determining and displaying sunset and sunrises to automatically display depending on when and where sunrises and sunsets are occurring in the world. In this embodiment, the view would automatically change to a camera that is recording a live sunrise or sunset and thereby follow the sun around the world.

In one of the embodiments, the system can provide a view that is live or real time. Near live is included in the meaning of live meaning a minor delay in the broadcast. By “live” is meant the camera is recording live and the only delay to the viewer's screen is the limitation of the speed of the transmission from the camera to the viewer's screen. Real time and live can be used interchangeably herein.

In some embodiments, the viewer's screen view can be arranged variously to tailor the view to the interests of the viewer. For example, a main larger view can be displayed on the screen and smaller views are displayed adjacent to the main view allowing the user to scroll between views.

Embodiments can be used to view a site or views of various categories of interest. For example, in one embodiment, a user “subscribes” to the views of another user. As an example, the view is from a property owned by a celebrity category providing the viewer the same or similar view a celebrity would have. In another embodiment, the view is a property owned by a friend/relative category and can be a means for connecting live with the friend/relative.

In one embodiment, the view is controlled by the viewer/user. The view can be part of a competition and the most and/or longest viewed view is displayed. This view can be considered the world's best view and can be assessed for example, daily, hourly, weekly or yearly. The view can be part of a competition for the best view in a category (city, building, park) and as such allows people to both vote by simply viewing or vote manually and clicking on likes etc. In a preferred embodiment, the completion is self-selecting by the number and/or length of views.

Thus, for example, the celebrity with the most viewed view from one of their real property webcams (such as vacation home or Hollywood) or other building domains could be considered the world's best celebrity view. The most and or longest scenic view, for example, of a mountain range or the ocean or the like can be considered the world's best scenic view. The most and/or longest viewed city scape can be considered the world's best city view. The most and/or longest viewed campsite view can be considered the world's best campsite view. The most and/or longest viewed of a combination of the above and more categories can be considered the world's best overall view.

In another embodiment, the view is a view shared by the viewer to followers as currently watching live or substantially live or substantially in real time and provides a means for the viewers to communicate with one another to form a community. In another embodiment, the viewer can generate a list of favorite views that is shamble with other viewers, including for example celebrity views, city views and scenic views. Thus, the view is generated by viewers and can be shared with all or selected other viewers.

In another embodiment, the view can be seen in an accelerated mode over time, e.g. over the last year to rapidly view the seasons on a particular view, or the recorded view can be annotated by viewers or an editor or curator to easily find highlights.

In yet another embodiment, the view can be controlled by viewer, e.g. zoomed in and out or panned. In this way, the viewer becomes the photographer. In addition, parameters can be placed on viewer operated camera modification such as the view can be modified if a certain number of viewers, e.g. at least ten, selected a certain view from a list of available views. For example, the camera or video input can be controlled by the viewers' buttons that allow it to be zoomed in or out, or panned. Having a number requirement to make camera adjustments prevents opposing forces of the viewers to select the angle and zoom most appropriate or satisfactory to a percentage of viewers or majority of viewers. This feature can be modified by the number of viewers currently live on a camera. For example, a single viewer can control the camera if they alone are watching. If there are multiple viewers, a certain percentage of the views can be required to select the zoom or pan of the camera to modify it. For example, 1, 2, 3, 4, 5, 10, 20, 30, 40, 50% or more can be required to click on/select a camera function modification to cause the camera to alter its view. The number of viewers making the request can be displayed at or near real time to the viewers/operators of the cameras.

One of the embodiments also provides a screen view for the view that can be only one major/large view or a major/large view with multiple smaller views or a multitude of small views or views of varying sizes. In one embodiment, the viewer can select their view(s). In another embodiment, no more than 100, 90, 80, 70, 60, 50, 40, 30, 20, 10, 9, 8, 7, 6, 5, 4, 2 views are found and displayed for each category.

In a preferred embodiment, provided is a method of providing electronic camera generated views to a user's screen comprising providing a curated view or platform of the views to the viewer wherein an electronic means of calculating views is utilized to display the current most active view or views. Typically, the view is video and can be provided by webcams. Thus, a consolidated webcam view or views can be provided. In a preferred embodiment, the view or views are provided live. This method utilizes one or more or combinations of the features set forth herein.

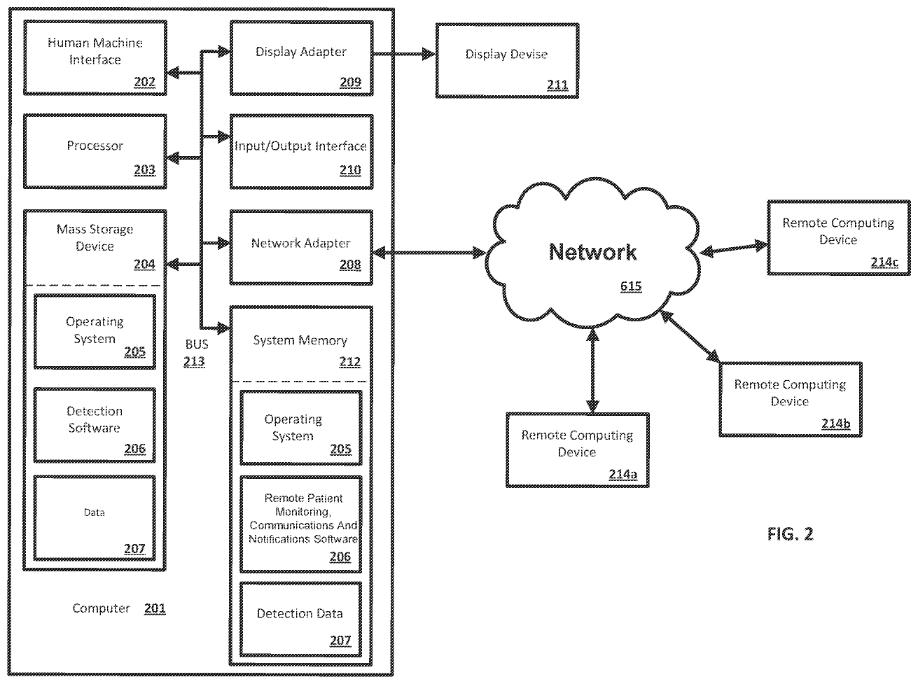

FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, smart phones, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 201. Computer 201 may comprise all or a portion of the server described with reference to FIG. 1. The components of the computer 201 can comprise, but are not limited to, one or more processors or processing units 203, a system memory 212, and a system bus 213 that couples various system components including the processor 203 to the system memory 212. In the case of multiple processing units 203, the system can utilize parallel computing. As used herein, “processor” 203 is a hardware device that is a part of the computer 201, such as the central processing unit, that performs calculations or other manipulations of data in accordance with instructions provided to the processor. Generally, the instructions comprise machine-executable code.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA). Universal Serial Bus (USB) and the like. The bus 213, and all buses specified in this description can also be implemented over a wired or wireless network connection and each of the subsystems, including the processor 203, a mass storage device 204, an operating system 205, software 206 to implements a method of providing an electronic video camera generated live view or views to a user's screen, data 207 method of providing an electronic video camera generated live view or views to a user's screen, a network adapter 208, system memory 212, an Input/Output Interface 210, a display adapter 209, a display device 211, and a human machine interface 202, can be contained within one or more remote computing devices 214 a,b,c at physically separate locations, connected through buses of this form, in effect implementing a fully distributed system. In one aspect, remote computing devices can comprise smart devices, such as smart phones, tablets, or portable personal electronic devices (like smart watches), electronic cameras, and the like.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as data 207 for providing an electronic video camera generated live view or views to a user's screen and/or program modules such as operating system 205 and software 206 for implementing the method of providing an electronic video camera generated live view or views to a user's screen that are immediately accessible to and/or are presently operated on by the processing unit 203.

In another aspect, the computer 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and the software 206 for implementing the method of providing an electronic video camera generated live view or views to a user's screen. Each of the operating system 205 and software 206 (or some combination thereof) can comprise elements of the programming and the method of providing an electronic video camera generated live view or views to a user's screen software 206. Data 207 can also be stored on the mass storage device 204. Data 207 can be stored in any of one or more databases known in the art. Examples of such databases comprise, DB2k, Microsoft® Access, Microsoft® SQL Server, Oracle®, mySQL, PostgreSQL, and the like. The databases can be centralized or distributed across multiple systems.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector, a computer, a smart phone, a smart TV, or any video-enabled device. In addition to the display device 211, other output peripheral devices can comprise components such as speakers (not shown) and a printer (not shown) which can be connected to the computer 201 via Input/Output Interface 210. Any step and/or result of the methods can be output in any form to an output device. Such output can be any form of visual representation, including, but not limited to, textual, graphical, animation, audio, tactile, and the like.

The computer 201 can operate in a networked environment using logical connections to one or more remote computing devices 214 a,b,c. By way of example, a remote computing device can be a personal computer, portable computer, a server, a router, a network computer, a peer device or other common network node, and so on. Logical connections between the computer 201 and a remote computing device 214 a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and the Internet 215.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of the method of providing an electronic video camera generated live view or views to a user's screen software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of providing an electronic video camera generated live view or views to a viewer's screen comprising:
providing a plurality of views to the viewer that are curated and categorized into a plurality of view categories;
receiving, from the viewer, a selection of one or more of the plurality of views;
displaying, on the screen the selected view or views, wherein the selected view is controlled by the viewer.

2. (canceled)

3. The method of claim 1, wherein the curation is provided in part by human means, or the curation uses both electronic and human means.

4. (canceled)

5. The method of claim 1, wherein the user is provided with generated live views from a plurality of cameras, but only views from cameras that are functional are displayed.

6. The method of claim 1, wherein the camera is a webcam.

7. (canceled)

8. The method of claim 1, wherein the screen is selected from the group consisting of a computer, TV, or handheld device.

9. The method of claim 1, wherein the plurality of views are categorized by one or more categories of interest.

10. The method of claim 1, wherein the plurality of views are categorized by a non-border defined category.

11. The method of claim 1, wherein only a main view is shown on the screen.

12. The method of claim 1, wherein a main view is shown on the screen and smaller views are shown adjacent to the main view allowing the user to scroll between views.

13. The method of claim 1, wherein providing a plurality of views to the viewer further comprises a substantially real time means of calculating views and providing the current most popular view or views to the viewer.

14. The method of claim 1, wherein the plurality of view categories include property owned by a celebrity, and property owned by a friend/relative.

15. (canceled)

16. (canceled)

17. The method of claim 1, wherein the camera angle and/or zoom is controlled by the viewer.

18. The method of claim 1, wherein each view of the plurality of views are part of a competition and a winning view is selected based on a most and/or longest viewed view from among the plurality of views.

19. The method of claim 18 wherein an algorithm is used to calculate the most viewed view from among the plurality of views.

20. The method of claim 1, wherein each of the plurality of views in one category of the plurality of categories is part of a competition for a best view in the category.

21. The method of claim 20, wherein a winner in one category of the plurality of categories is selected by number and/or length of views from among the plurality of views in the one category of the plurality of categories.

22. The method of claim 1, wherein the view is a view shared by the viewer to followers as currently watching substantially in real time.

23. The method of claim 1, wherein the viewer generates a list of favorite views that is sharable with other viewers.

24. The method of claim 1, wherein the view is generated by viewers and can be shared with all or selected other viewers.

25. The method of claim 1, wherein the view can be seen in an accelerated time lapsed mode.

26. (canceled)

27. (canceled)

28. The method of claim 1, wherein the view provides the ability to view past events recorded by the camera and the past events are further curated and tagged to the viewer's interest.

29. (canceled)

30. A method of providing webcam generated live views to a user's screen comprising providing a curated live view or platform of the views to the viewer wherein an electronic means of calculating views is utilized to display the current most active view or views.

31. (canceled)

32. (canceled)

33. (canceled)

34. (canceled)
